(19) United States
(12) Patent Application Publication
(10) Pub. No.: US 2026/0085660 A1
(43) Pub. Date: Mar. 26, 2026

(54) SYSTEM FOR SECURING CLIMBING STRUCTURES TO VERTICAL BODIES

(71) Applicant: LEUNAMME TECHNOLOGY S.L., MUTILVA (NAVARRA) (ES)

(72) Inventors: Emmanuel GARCIA DE LA PEÑA RAZQUIN, MUTILVA (NAVARRA) (ES); Aitor REPARAZ EXTRAMIANA, MUTILVA (NAVARRA) (ES)

(21) Appl. No.: 19/113,559

(22) PCT Filed: Sep. 12, 2023
(86) PCT No.: PCT/ES2023/070552

§ 371 Date: Mar. 20, 2025

(30) Foreign Application Priority Data
Sep. 23, 2022 (ES) P202230820

(51) Int. Cl. F03D 80/00; F16M 13/02

(52) U.S. Cl. CPC F03D 80/00; F16M 13/022

(57) ABSTRACT

A system for fastening climbing structures to vertical bodies, comprising fastening structures that allow a climbing structure to be moved in steps along a vertical body, such as a wind turbine tower, each fastening structure comprising a clamp jaw (1) with which it is pre-adjusted to the vertical body by a set of callipers (1.1), and a clamp (2) with which it is clamped to the vertical body by pads (4) which are joined to a hinged arm (6) and which are pressed by a webbing (7) against the surface of the vertical body.

### TECHNICAL FIELD

The present invention is related to constructions at great heights, referring to a system for fastening climbing structures to vertical bodies, such as wind turbine towers, in order to allow parts and/or tools to be lifted and lowered comfortably and without the need to use independent lifting machines, such as cranes of any kind. In said concept, the particular field of application of the invention is the wind industry, although it can be applied in other industrial fields without limitation.

### STATE OF THE ART

For the lifting of loads in high-rise constructions, such as the assembly of structures or the replacement of wind turbine components, cranes are typically used which form a structure with their jib that is independent of the construction on which the load is to be placed or picked up. From said jib hangs a hook suspended from a cable which is normally fitted with a return system to multiply the load that can be lifted by the winch. Said hook is attached to the load to be lifted by means of webbings which surround the parts to be lifted, or chains which are passed through lifting eyebolts or a rocker arm or tooling specifically designed for lifting the component in question.

The state of the art includes a document US2021270242 which discloses a large component lifting device for reaching great heights. It contains a collar for deploying the webbing around the tower to be climbed guided by a magnetic trolley, friction pads on a single sector of the tower, a system for moving the collars closer to and further away from the telescopic climbing structure and a ratchet on the drum holding the drum to lock the strap. This collar has the following problems or limitations due to its design:
Magnetic trolley: cannot be used on non-steel towers. If the surface is wet, the control of the trolley is very complex and unreliable.
Pads in a single tower sector. As they are not distributed around the entire perimeter of the tower, the stresses transmitted to the tower are greater, preventing the lifting of high tonnage loads.
The stressing and destressing manoeuvres of the webbing produces a horizontal movement of the stressing trolley, which makes it necessary to incorporate an additional linear device to move the sections closer and further apart.
Ratchet locking: due to the stressing forces transmitted to the webbing when applying load to the pad actuators, there is an undesired effect of compacting the webbing winding on the drum, which prevents the pressure on the pads from being reached before the pad cylinders have been used up.

Moreover, document US 2020256318 discloses a friction collar that surrounds the tower to be climbed, which main problem is the impossibility of overcoming obstacles or projections of the tower itself, as it always surrounds the tower in a stressed or destressed state, and cannot move further away from the tower than the wheels of the trolley allow it to do so. This detail is key as many wind turbine towers have anemometers, aviation lights, hatches, ventilation grilles, etc., which protrude from the tower surface and would cause the collar to be jammed. Document US2019219035 proposes a solution that improves the lifting technique by using climbing structures that are fastened on the wind turbine tower, the fastening being established by means of structural straps provided with webbings which open and close sequentially to enable the climbing structure to be lifted and/or lowered along the vertical body. In this case, the webbing straps encircle the perimeter of the vertical body and are stressed by a mechanism to hold the climbing structure in place. Similarly to document US 2020256318, it discloses collars that are always surrounding the entire tower preventing it from overcoming obstacles. In this invention, moreover, it is not resolved how to prevent the webbing from remaining crossed when it is destressed and activating the climbing movement.

Due to the aforementioned problems and drawbacks, it is evident that it is necessary to develop a solution that optimises the process of tying climbing structures by friction to the tower to allow the lifting of high tonnage parts at great heights, while guaranteeing the safety and integrity of the components of the system and the operators.

### OBJECT OF THE INVENTION

In order to eliminate the drawbacks of the known techniques, the present invention proposes a system for fastening climbing structures to vertical bodies, such as wind turbine towers, achieving conditions that advantageously allow the integrity and safety of the components handled during the process of lifting and lowering parts in constructions of great heights to be guaranteed, since the climbing structure allows the parts to be fastened and lifted in a robust manner on the vertical body to which the same are being fastened.

This system of the invention comprises fastening structures attached to a climbing structure used to raise or lower an element fastened to said climbing structure along the vertical body by extending and retracting the climbing structure in combination with a closing and opening movement of the fastening structures. Each fastening structure comprises an open clamp with press-fit pads for fitting to the vertical body, with a clamp jaw for pre-adjusting the pads to the perimeter of the vertical structure, the clamp comprising a hinged arm configured to close and open the clamp around the vertical structure, and with a webbing that rests on the pads to press them against the vertical body by stressing through a locking assembly configured to wind and lock the webbing to determine the pressure on the pads and establish the fastening of the climbing structure on the vertical body.

In this way, a pre-adjustment if performed by means of the clamp with the movement of the clamp jaw and the arm closure, which ensures the positioning of the clamp, and by stressing with the webbing the adjustment for fastening and locking the fastening structures is carried out during the movement of the climbing structure.

Due to this configuration it is possible to open the clamp jaw during the opening of the fastening structures in the extension or retraction movement of the climbing structure, unlike the state of the art in which the fastening structure consists of a strap or webbing that is stressed or destressed to produce the fastening but which remains closed during lifting and lowering surrounding the vertical body. This feature makes it possible to spare protrusions such as signalling beacons or tensioning cables that are provided on certain wind turbines, or to avoid friction and the consequent wear of the straps or webbing during movement, which, in addition to the pads being those which make contact with the vertical body, the friction of direct contact of the webbing is avoided.

According to a feature of the invention, the webbing supports and exerts pressure on the pads by means of a pad holder, having a pad holder associated with at least one corresponding pad.

This configuration ensures even pressure and keeps the adjustment webbing in a guided position to guarantee optimum fastening of the strap by generating a stress that is transformed into pressure on the pads, applying them against the surface of the vertical body with a force that allows the climbing structure to be firmly held in place without risk of detachment.

According to another feature of the invention, the closing of the clamp is established by means of a closing system for attaching the hinged arm to the webbing holder located opposite to the fixed end of the hinged arm.

Thus, the hinged arm in the open position of the clamp is retracted and for closing the hinged arm, preferably by means of a wheel, it slides around the vertical body until it abuts against the webbing holder, in which it is fixed.

Preferably, the closing system comprises socket parts preferably attached to the webbing holder, and at least one bolt actuated by a motor, said bolt being configured to fasten crimps of the free end of the hinged arm. This configuration provides greater security when closing the clamp.

According to another aspect of the invention, the locking assembly comprises a drum that winds and unwinds the webbing to apply stress thereto, and an eyelet cylinder through which the webbing passes, the eyelet cylinder having a pinion that is moved by a linear actuator along a rack to a stop position.

The stress exerted by a winding device such as a drum may not be sufficient to attach the fastening structures for certain applications where withstanding high strains is required. For this purpose, the eyelet cylinder provides an additional winding in the cylinder itself, which increases the tension of the webbing and consequently the pressure exerted on the pads.

Also, preferably, the eyelet cylinder comprises a locking system for locking the same in the stop position, the cylinder comprising a geometry corresponding to at least one locking part located at the limit switch of the rack in which it fits due to the action of the linear actuator. This ensures that the webbing is not destressed.

If it is also desired to provide the system with a greater stress for fastening security, the clamp is provided, in at least one point of its perimeter, to comprise a tensioning system to apply an outward thrust on the webbing to increase the pressure on the pads, said tensioning system being preferably with a cylinder with a piston that by means of a connecting rod pushes the webbing outwards when it is locked. “Outwards” is understood as the position opposite to the vertical body, i.e. from said vertical body to the outside.

Preferably, the clamp jaw comprises a cross beam at the portion thereof closest to the vertical body, sandwiched between two callipers of the clamp jaw, comprising an intermediate joint for moving a pad associated with said cross beam.

In this way, and preferably with a motorised joint, it is possible to separate the pad from the vertical body, avoiding the friction of the pad against any protrusions or beacons arranged on the surface of the vertical body.

For all these reasons, the claimed system has features that make it advantageous, acquiring a life of its own and a preferential character for the application function for which it is intended, making it possible to avoid the need to use large lifting machines and maintenance costs in constructions of great heights, such as the constructive assembly of wind turbines.

### DESCRIPTION OF THE FIGURES

To assist a better understanding of the functionality of the invention, illustrative drawings, which are not limiting, are attached to the description.

FIG. 1 shows a perspective view of an exemplary embodiment of a climbing structural assembly comprising a fastening system according to the system of the invention.

FIG. 2 is a perspective view of the fastening system of the invention with the clamp open with a hinged closing arm in the open position.

FIG. 3 is a perspective view of the fastening system of the invention with the clamp open with a hinged closing arm in an intermediate position.

FIG. 4 is a perspective view of the fastening system of the invention with the clamp closed with an articulated closing arm in the final closed position.

FIG. 5 is a view as above, but from the rear portion of the fastening system, in this case the closed clamp for a smaller diameter vertical body.

FIG. 6 is a plan view of the fastening structure that is the object of the invention.

FIG. 7 is a schematic view of the clamp closing mechanism of the fastening structure, at the instant prior to the engagement of the hinged arm for closing the clamp.

FIG. 8 is a plan view of a pad and its additional stressing mechanism.

FIG. 9 shows a perspective view of the locking assembly with the cylinder with locked eyelet.

FIG. 10 is a plan view of the locking assembly with the actuator acting on the eyelet cylinder in the initial position prior to stressing.

FIG. 11 is a plan view of the locking assembly as above, but with the actuator at the limit switch with the eyelet cylinder in its locked position as in FIG. 9.

### DETAILED DESCRIPTION OF THE INVENTION

In accordance with the present invention, a system is proposed for fastening climbing structures (3) on vertical bodies, for high-rise constructions or maintenance tasks, such as wind turbines, wherein the vertical body on which the climbing is carried out is the wind turbine tower.

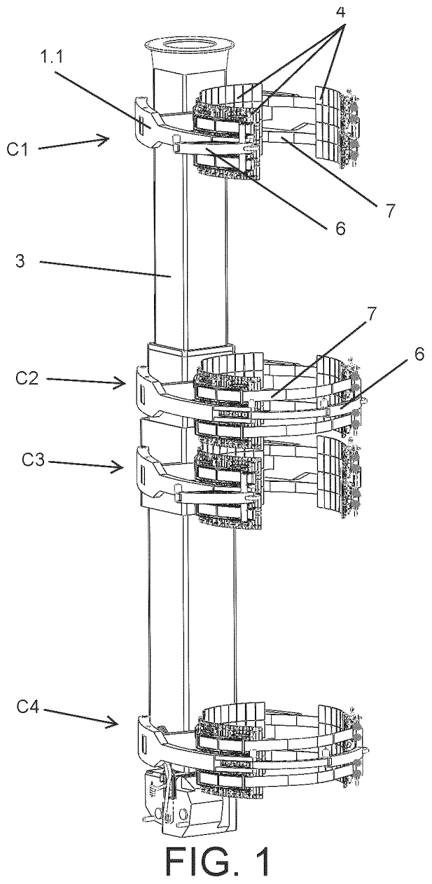

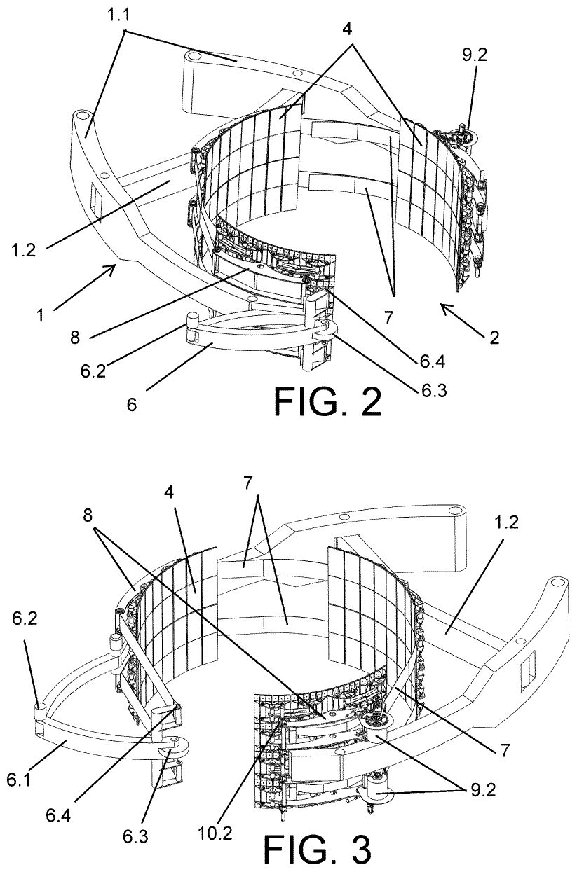

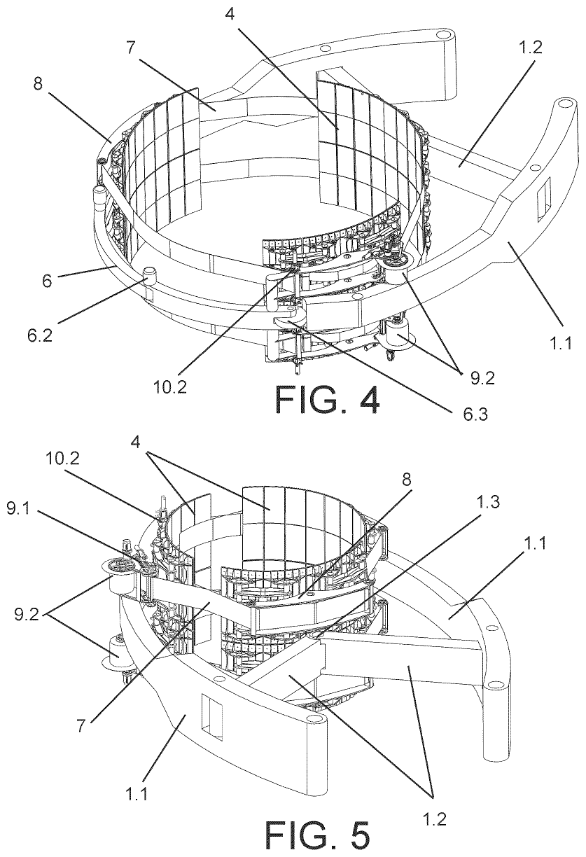

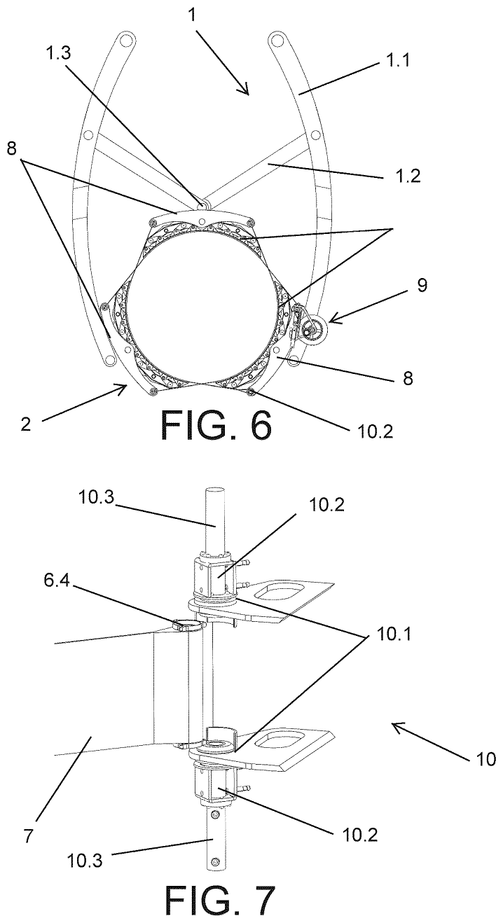

In order to carry out the climbing with the system of the invention, fastening structures (C1, C2, C3 and C4) are used, the number of which can vary according to the requirements of the installation. Each of them comprises, as shown in FIGS. 1 to 6, a clamp jaw (1) and a clamp (2), so that the clamp jaw (1) is used to pre-adjust the fastening structure (C1, C2, C3, C4) on the vertical body or wind turbine tower, the fastening structures (C1, C2, C3, C4) being preferably attached by welding to the climbing structure (3). The clamp (2) is used to establish a fastening clamp on the vertical body on which the climbing is carried out.

The clamp jaw (1) comprises a set of callipers (1.1), preferably with a cross beam (1.2) sandwiched between the same, said cross beam (1.2) being formed by segments joined by means of a joint (1.3), which is moved by extending one of the two cross beams (1.2) with an actuator, forming an articulated assembly that enables the clamp jaw (1) to be adapted to any diameter of the vertical body on which it is clamped.

Moreover, the clamp (2) incorporates pads (4) intended to rest directly on the surface of the vertical body. So that the clamp (2) preferably comprises three pads (4), one pad (4) being linked to one calliper (1.1) and opposite thereto another pad (4) being linked to the other calliper (1.1), and the third pad (4) being linked to the cross beam (1.2). Thus, in a first step, the callipers (1.1) of the clamp jaw (1) are actuated by means of a corresponding actuator of each calliper (1.1) adjusting the side pads (4), and the cross beam (1.2) with the joint (1.3) moves the rear pad (4), providing a pre-adjustment of the clamp (2) to the vertical body.

The clamp (2) also comprises a hinged arm (6), by means of which the same can be closed and opened around the perimeter of the vertical body, with a webbing (7) resting on the pads (4), which starts at one end of the hinged arm (6) and passes through webbing holders (8) until it reaches a locking assembly (9) that pulls said webbing (7) to transmit a pressure thrust to the pads (4) that ensures the fastening of the climbing structure (3) on the vertical body.

The hinged arm (6) comprises two segments (6.1) joined by means of a joint (6.2) that is motorised or moved by a linear actuator, one end of said hinged arm (6) being preferably attached to the end of one of the callipers (1.1) of the clamp jaw (1) by means of a motorised joint, while the other end is free to close and open the clamp (2).

Therefore, in a second step, after the pre-adjustment, the clamp (2) is closed by means of the hinged arm (6) which moves around the vertical body up to an attachment stop of the clamp (2).

To facilitate the closing and opening movement of the clamp (2), the free end of the hinged arm (6) incorporates a wheel (6.3) with which it rests on the surface of the vertical body. As can be seen in FIG. 7, the hinged arm (6) has at its free end hollow crimps (6.4), in which one end of the webbing (7) is hooked.

The closure of the clamp (2) is established by means of a closing system (10), said closing system (10) comprising socket parts (10.1) of the crimps (6.4) and a bolt (10.2) actuated by actuators (10.3), which is inserted into the hollow of the crimps (6.4) to keep the clamp (2) closed. As can be seen in FIG. 7, the socket parts (10.1) preferably comprise a stop that establishes the positioning of the crimps (6.4) to centre the same with respect to the movement of the bolt (10.2). In addition, a bolt (10.2) with its corresponding actuator (10.3) is provided for attachment at the top and another at the bottom of the free end of the hinged arm (6).

In this way a pre-adjustment of the pads (4) is established With the clamp (2) completely closed.

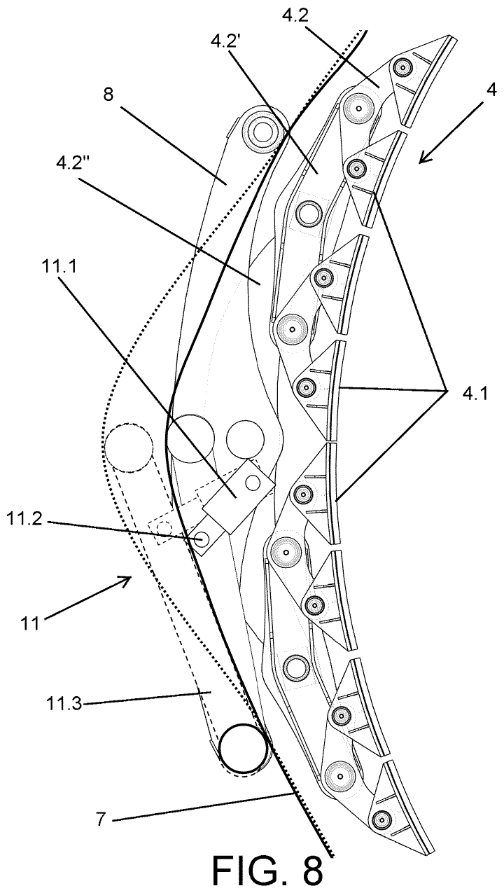

As shown in FIG. 8, the pads (4) are distributed in groups (4.1), which are joined together by means of leaf springs (4.2) through the ends of which swinging shafts (4.3) pass, providing freedom of movement so that the pads (4) can adapt to the surface of the vertical body. According to the preferred embodiment shown in FIG. 8, each group of pads (4.1) is grouped two by two, comprising a second leaf spring (4.2′) that hingedly joins four groups of pads (4.1). In turn, it comprises a third leaf spring (4.2″) which hingedly joins two groups of four pads (4.1).

The webbing (7) passes over the third leaf springs (4.2″), which is supported and inserted in the webbing holders (8) that are located over the pads (4), comprising one webbing holder (8) for each pad (4), i.e. in the example shown with three webbing holders (8). So the webbing holders (8) support and guide the webbing (7).

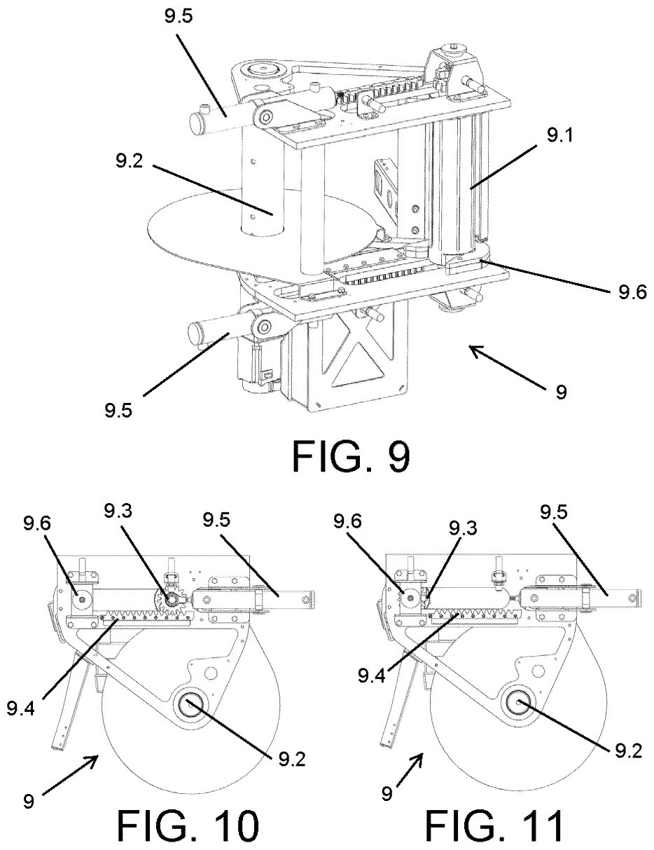

At this point, the webbing (7) is retracted into a locking assembly (9). Said locking assembly (9), as can be seen in FIGS. 9-11, comprises a motorised drum (9.2) that winds or unwinds the webbing (7), so that when the webbing (7) is wound up it exerts tension on the same, and when it rests on the webbing holders (8) it presses the latter against the third leaf spring (4.2″) that transmits the pressure to the pads (4) making the necessary fastening and locking adjustment to fasten the climbing structure (3) to the vertical body.

However, said lock may not be sufficient for certain applications or additional security may be desired. In this case, the locking assembly (9) comprises an eyelet cylinder (9.1), through which the webbing (7) passes, while a pinion (9.3) connected to the eyelet cylinder (9.1) and running along a rack (9.4) driven by a linear actuator (9.5) moves causing the eyelet cylinder (9.1) to rotate, winding the webbing (7) and consequently applying additional stress to the webbing (7) which causes a further adjustment and safety locking of the pads (4).

Said eyelet cylinder (9.1) moves to the limit switch of the linear actuator (9.5) and is locked by the retention established by said linear actuator (9.5).

However, according to one design option, the eyelet cylinder (9.1) moves until it fits into a locking part (9.6), so that the eyelet cylinder (9.1) has a geometry corresponding to the locking part (9.6) that establishes a locking retention that keeps the webbing (7) stressed more securely than with the brake provided by the drum motor (9.2) or the linear actuator (9.5) of the eyelet cylinder (9.1).

Although the above is the preferred embodiment, according to an alternative embodiment, the webbing (7) could be locked by means of a motor that rotates the eyelet cylinder (9.1) and a second actuator transversely entering with a bolt or a horseshoe to lock the eyelet cylinder (9.1) once it has sufficiently wound up the webbing (7) to ensure its locking.

According to an alternative embodiment, in order to establish a greater stress on the webbing (7) and therefore higher pressure on the pads (4) for the fastening adjustment of the fastening structures (C1, C2, C3, C4) on the vertical body, as can be seen in FIG. 8, the clamp (2) preferably on the webbing holder (8) comprises a tensioning system (11) with a cylinder (11.1) provided with a piston (11.2) that moves a connecting rod (11.3) outwards, so that it pushes the webbing (7) further stressing the same, which increases the pressure on the third leaf spring (4.2″) and consequently on the pads (4).

It is provided that instead of said cylinder (11.1) with piston (11.2), any type of actuator with or without connecting rod (11.3) can be used, as long as this force is exerted outwards to push the webbing (7).

As alternatives to said tensioning system mechanism (11), an inflatable chamber or bag is provided between the pad and the webbing (7) to act as a linear actuator; or an additional drum or rotary actuator is provided to stress the webbing (7) to establish the necessary pressure on the pads (4) for a secure fastening.

With all this, by means of the fastening structures (C1), (C2), (C3) and (C4), attached to the climbing structure (3), said climbing structure (3) can be moved in steps along the vertical body in order to lift or lower parts.

For the ascent process, the first step is to close the clamps (2) of the fastening structures (C1) and (C3) on the vertical body, carrying out the first and second steps described above for the pre-adjustment and closing of the clamps (2), to subsequently carry out the pre-stressing of the webbing (7) with the drum (9.2). The webbing (7) is then stressed a second time by winding the same onto the eyelet cylinder (9.1), locking the webbing (7) by means of the part (9.6) to prevent it from unwinding. Finally, a third stressing is applied to the webbing (7) by means of the piston (11.2) of the webbing holder (8).

Once the fastening structures (C1) and (C3) have been completely closed, the fastening structures (C2) and (C4) are opened with respect to the vertical body, which is carried out in a phase sequence as described above, but in reverse order. In this phase sequence, the function of the beam (1.2) is particularly noteworthy, which by means of the sliding joint (1.3) removes the pad (4) associated therewith, being separated from the vertical body, thus preventing the pad (4) from rubbing and avoiding collisions with elements that protrude from the surface of the vertical body.

Once the fastening structures (C2) and (C4) have been opened, said fastening structures (C2) and (C4) are moved along the vertical body, taking the climbing structure (3) therewith, until said fastening structures (C2) and (C4) make contact with the fastening structures (C1) and (C3), after which the process of another advance movement along the vertical body begins again, with the closing of the fastening structures (C2) and (C4) and the opening of the fastening structures (C1) and (C3), and so on until the desired position is reached.

Any type of actuating mechanism with optical or similar sensors can be incorporated to control the deployment and retraction of the hinged arm (6) of the clamp (2), without altering the essence of the invention.

Moreover, the application of the fastening system that is the object of the invention is preferably intended for the constructive assembly of wind turbines in the wind industry, but this application is not limiting, as the system can be used for any other type of construction in which the assembly of parts at great heights must be carried out with the same concept.

1. A system for fastening climbing structures to vertical bodies, comprising fastening structures (C1, C2, C3, C4) attached to a climbing structure (3) to lift or lower an element fastened to a climbing structure (3) along a vertical body by extending and retracting the climbing structure (3) in combination with a closing and opening movement of the fastening structures (C1, C2, C3, C4), wherein each fastening structure (C1, C2, C3, C4) comprises an open clamp (2) with press-fit pads (4) for fitting to the vertical body, with a clamp jaw (1) for pre-adjusting the press-fit pads (4) to the perimeter of the vertical structure, the clamp (2) comprising a hinged arm (6) configured to close and open the clamp (2) around the vertical structure, and with a webbing (7) that rests on the press-fit pads (4) to press them against the vertical body by means of stressing through a locking assembly (9) configured to wind and lock the webbing (7) to determine a pressure on the press-fit pads and establish the fastening of the climbing structure (3) on the vertical body.

2. The system for fastening climbing structures to vertical bodies, according to claim 1, wherein the webbing (7) rests on and exerts pressure on the press-fit pads (4) by means of a webbing holder (8) associated with at least one pad of the press-fit pads (4).

3. The system for fastening climbing structures to vertical bodies, according to claim 2, wherein the closing of the clamp (2) is established by means of a closing system (10) for attaching the hinged arm (6) to the webbing holder (8) opposite to the fixed end of the hinged arm (6).

4. The system for fastening climbing structures to vertical bodies, according to claim 3, wherein the closing system (10) comprises socket parts (10.1) and at least one bolt (10.2) actuated by an actuator (10.3) and configured to fasten crimps (6.4) of the free end of the hinged arm (6).

5. The system for fastening climbing structures to vertical bodies, according to claim 1, wherein the hinged arm (6) incorporates a wheel (6.3) at the free end with which it slides over the surface of the vertical body.

6. The system for fastening climbing structures to vertical bodies, according to claim 1, wherein the locking assembly (9) comprises a drum (9.2) which winds and unwinds the webbing (7) and an eyelet cylinder (9.1) through which the webbing (7) passes, the eyelet cylinder (9.1) with a pinion (9.3) that is moved by a linear actuator (9.5) along a rack (9.4) to a stop position.

7. The system for fastening climbing structures to vertical bodies, according to claim 6, wherein the eyelet cylinder (9.1) has a locking system for locking the same in the stop position, the cylinder comprising a geometry corresponding to at least one locking part (9.6) located at the limit switch of the rack (9.4) in which it fits due to the action of the linear actuator (9.5).

8. The system for fastening climbing structures to vertical bodies, according to claim 2, wherein the webbing holder (8) rests on third leaf springs (4.2″) that join groups (4.1) of the press-fit pads

9. The system for fastening climbing structures to vertical bodies, according to claim 1, wherein the clamp (2) comprises, at least at one point of the perimeter, a tensioning system (11) that pushes the webbing (7) outwards, increasing the pressure on the press-fit pads (4).

10. The system for fastening climbing structures to vertical bodies, according to claim 9, wherein the tensioning system (11) comprises a cylinder (11.1) with a piston (11.2) which, by means of a connecting rod (11.3) or directly, pushes on the webbing (7) to increase the pressure on the press-fit pads (4).

11. The system for fastening climbing structures to vertical bodies, according to claim 1, wherein the clamp (1) comprises a cross beam (1.2), at the portion thereof closest to the vertical body, sandwiched between two callipers (1.1) of the clamp jaw (1), comprising a joint (1.3) for moving a pad associated with said cross beam (1.2) in the opening of the clamp (2).
